(19) United States
(12) Patent Application Publication
(10) Pub. No.: US 2004/0230511 A1
(43) Pub. Date: Nov. 18, 2004

(54) Global sales by referral network

(76) Inventors: Narasimhan P. Kannan, McLean, VA (US); Leslie M. Kannan, McLean, VA (US); Ariane V. Kannan, McLean, VA (US); Camille C. Kannnan, McLean, VA (US)

Correspondence Address: James C. Wray, Suite 300, 1493 Chain Bridge Road, McLean, VA, 22101, US

(21) Appl. No.: 10/868,844

(22) Filed: Jun. 17, 2004

Related U.S. Application Data
(63) Continuation-in-part of application No. PCT/US02/40723, filed on Dec. 20, 2002.
(60) Provisional application No. 60/341,264, filed on Dec. 20, 2001.

(51) Int. Cl. G06F 17/60

(52) U.S. Cl. 705/35

(57) ABSTRACT

PEER BAZAAR enables, fosters and manages a global peer-to-peer sales process through a global peer-to-peer e-commerce network to distribute consumer products/services through its business model, proprietary software, and web-hosting infrastructure. PEER BAZAAR enters into distribution agreements with publishers and owners of goods/services and digital assets. The data about the goods/services and the digital assets are stored in a central server and downloaded upon completion of a peer-to-peer and/or user transaction. Users purchase products/services by downloading from PEER BAZAAR's website. Users then try out the products/services. If they are satisfied or not, they write reviews and recommend the product/service to others. Such referrals are recorded and tracked, and if anyone downloads the goods/services and/or title responsive to the referral, then the referring individual gets a reviewer credit or the like which may be a percentage from the sale of the goods/services/assets.

This application is a continuation-in-part of PCT Application PCT/US02/40723 filed Dec. 20, 2002, which claims the benefit of priority of U.S. Provisional Application 60/341,264 filed Dec. 20, 2001.

### BACKGROUND OF THE INVENTION

Peer-to-peer marketing and selling has been well established as a successful business model that has created multi-level-marketing giants such as Amway, Avon, and Tupperware. The Internet has revolutionized e-commerce between business-to-consumers and business-to-business. The consumer-to-consumer selling is done mainly through auctions of articles. The peer-to-peer e-commerce channel for distribution of products and services is still wide open.

In 2002, $60 billion was spent in the U.S. on online retail sales of consumer products. This has been growing at a rate of 100% for the past five years and is projected to increase steadily in the future. If one assumes that 20% of the $60 billion currently spent on online retail purchases, goes to pay middlemen in the distribution channel, then the potential addressable market in dollar terms is 12 billion dollars. Online purchase growth predictions indicate that online purchases will be anywhere from 300 to 500 billion dollars in the next five to six years.

US consumers spend on an average $300 per person per year on digital and other products such as books, home videos, recorded music, magazines and video games. These are the fastest growing segments of the entertainment market and are expected to grow to $400 per person per year by 2004. The total market size was about $40 billion in 1999 and is expected to grow. The industry spends over $80 billion in creating digital products and in publishing, promoting, and selling the products. This is also expected to grow to over $100 billion. Over 60% of these expenses are attributable to product packaging, distribution, and marketing.

Peer-to-peer distribution is a brand new arena for the Internet and currently there is no viable concept emerging that is both legal and economically viable.

Currently, product reviews are available on Internet sites such as Amazon, Ebay, and Cnet. However, these reviews are either written by amateurs or by manufacturer representatives. The reviews are shoddy, biased, often not truthful and definitely lack quality control. These sites accept advertising dollars from the manufacturers and as a result their impartiality is lost.

A need exists for a workable business model to enable, foster, and manage a global peer-to-peer distribution channel for consumer products and services.

### SUMMARY OF THE INVENTION

The present invention, PEER BAZAAR (PB), provides the technology and a business method necessary to enable, foster and manage a global peer-to-peer sales process. This invention enables a global peer-to-peer e-commerce network to distribute consumer products through its unique business model, proprietary software, and web-hosting infrastructure. This invention exploits the viral expansion possibilities of the Internet and uses the peer-to-peer sales process. The invention consists of two components: 1) a product review method that ensures integrity, trust and avoids conflicts of interests, and 2) a method of also treating every consumer as a reseller by the process of referrals. The use of a referral process makes each consumer a sales agent when they recommend a product or service to their peers. Incentives may be provided for the process of referrals.

The principle revenue sources are fees for subscription by members and for transactions conducted. For subscriptions PEER BAZAAR enters into agreements with manufacturers and suppliers of products and services to post their responses to reviews by end-users of their products and for transaction revenues. Subscriptions are also entered into with consumers and end users to access the stored data and reviews about the products and services. Subscription fees range from no fee to any amount per subscription period. PEER BAZAAR enters into distribution agreements with publishers and owners of proprietary assets such as music, video, books, magazines, and periodicals who wish to use a controlled peer-to-peer network. In this case, the digital assets are stored in a central server (for example, ASP model) and downloaded upon completion of a peer-to-peer transaction. However, the invention encompasses all consumer related products and services and is not merely limited to digital assets. PEER BAZAAR is useful for sales, reselling, distribution, etc. of digital and non-digital products/services. It may especially be attractive, for example, for distribution of digital products.

One example is where each member has a user name and password and starts out with, for example, an incentive fee for referring a new member. Users may be required to register with a peer-to-peer payment system such as, for example, “Pay Pal” or “Yahoo Pay”. After user log-in to a central web-site, the initial screen may show their account balances, current cash balance, income earned from reviews, transactions, referrals to date and for the year, and expenses for purchases, and the like. The initial screen has links to take the user to the current online database of available products/services, for example, new titles of digital assets, descriptions, and the like. Users purchase products/services by downloading from PEER BAZAAR's website. Users then try out the products/services. If they are satisfied, they can write reviews and recommend the product/service to their peers. Such referrals are recorded and tracked, and if anyone completes a transaction responsive to a referral, then the referring individual gets a percentage of the sale.

PEER BAZAAR also solves the problem of “Digital Piracy” which is low cost distribution through the Internet and illegal copying occurring globally. PEER BAZAAR's long-term solution creates a strong economic incentive for individuals who can sell digital assets to their peers and make money rather than give it away for free. A well-organized peer-to-peer global sales network creates an orderly channel for distribution of assets with built-in incentives at the individual levels to minimize piracy over the Internet. PEER BAZAAR uses the Internet to create, foster, and develop this peer-to-peer network. The network is the asset PEER BAZAAR leverages to distribute any number of products/services. The method of organizing, hosting, and managing a global peer-to-peer sales network and technology is inclusive of the present invention's capabilities.

These and further and other objects and features of the invention are apparent in the disclosure, which includes the above and ongoing written specification, claims and drawings.

### BRIEF DESCRIPTION OF THE DRAWINGS

FIG. 1 is a flow chart of PEER BAZAAR.

FIG. 2A is a flow chart of the Global Referral and Buyer's Club for Products and Services.

FIG. 2B is a continuation of FIG. 2A.

FIG. 3 is a flow chart of the review ranking and credit assignment scheme.

FIG. 4 is a flow chart of the global network supplier's interactions.

FIG. 5 is a flow chart describing user experience in PEER BAZAAR.

FIG. 6 is a flow chart detailing the PEER BAZAAR subsystem interaction.

FIG. 7 is a flow chart of the checkout system of PEER BAZAAR.

FIG. 8 is a flow chart of the supplier's interactions in PEER BAZAAR.

FIG. 9 shows the sequence of invocation of classes when a user triggers an action from the browser.

FIG. 10 is a package diagram and displays various packages involved in the application.

### DETAILED DESCRIPTION OF THE PREFERRED EMBODIMENTS

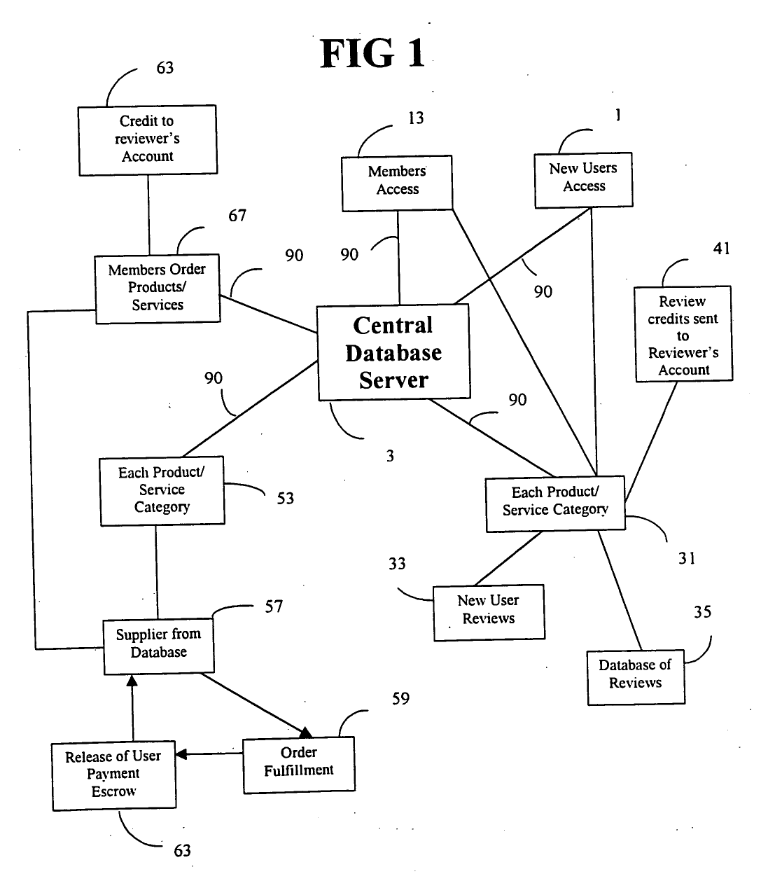

FIG. 1 is a flow chart of PEER BAZAAR. Users, new users 1 or existing members 13 who have paid subscription charges, connect 90 to a central database server 3 through any access device such as, but not limited to, personal computers, cellular devices, and/or telephones. The central database server 3 provides users with access to a Buyer's Club for Products and Services.

When users access each product/service category 31, the user may access new user reviews 33 and/or the database of reviews 35. When users buy a product/service based on another user's review of that product/service, review credits are sent to the reviewer's account 41.

When users access each product/service category 53 or order products/services 67, a supplier is provided from the database 57, the order is fulfilled 59 and the user's payment escrow is released 63. When the user buys a product/service after viewing another user's review of that product/service, a credit is sent to the reviewer's account 63.

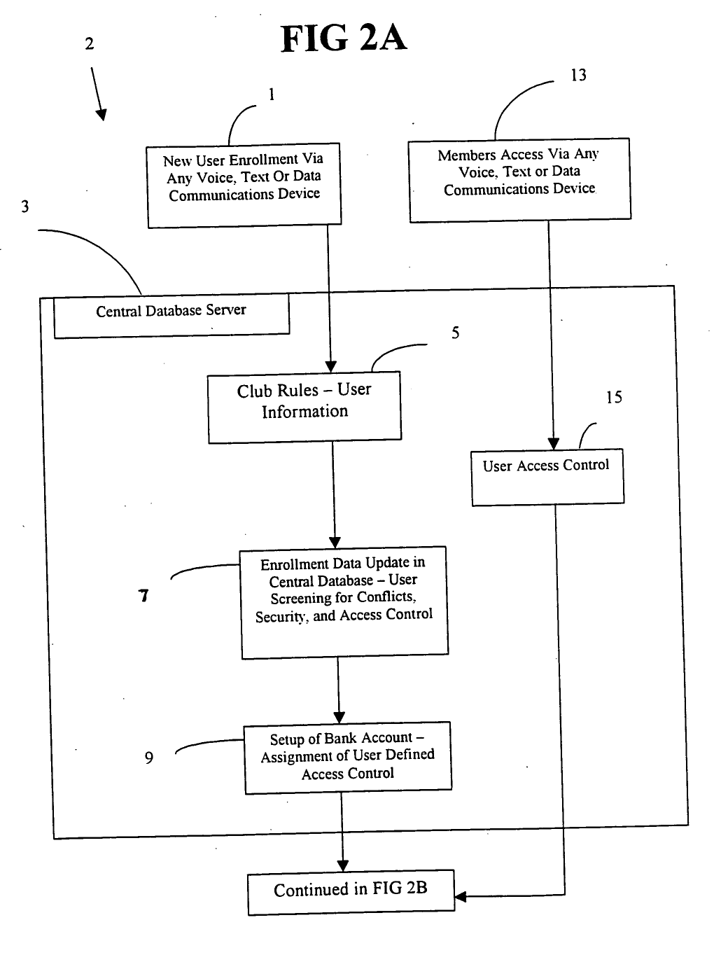

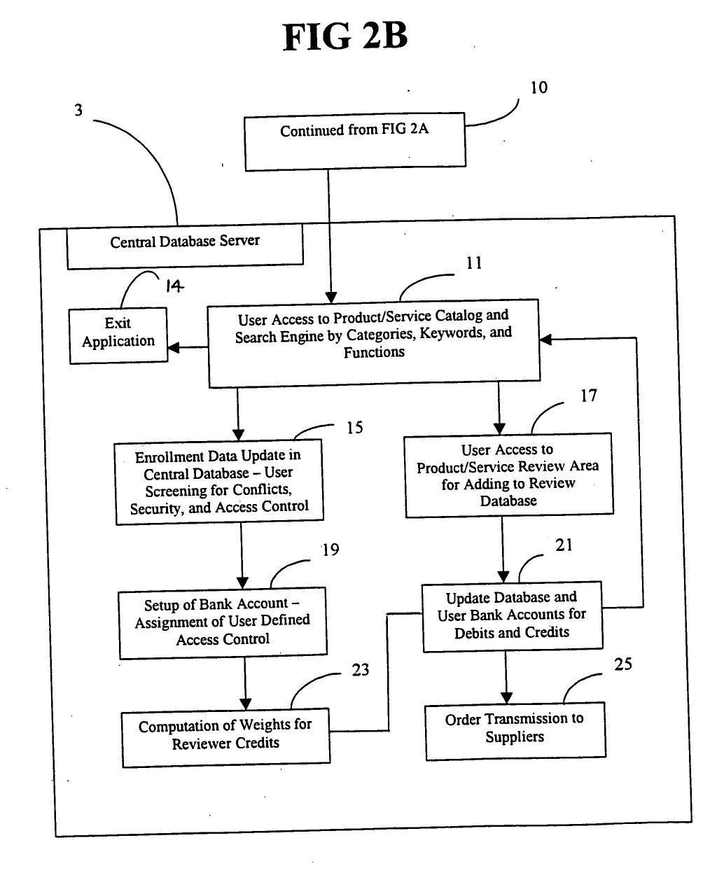

FIGS. 2A and 2B are flow charts of a Global Referral and Buyer's Club for products and services 2 detailing new user access and member access. A New User enrollment 1 may occur through any access device such as, but not limited to, personal computers, cellular devices, modems, PDAs, and/or telephones. The new user connects to the central database server 3 where the new user is first alerted to the Club Rules and is prompted to enter user information 5. The user selects a unique password and a code-name or a pseudonym to maintain anonymity. New users may provide, as an option, a profile about themselves.

The new user's enrollment data 7 is updated in the central database 3 and screened for conflicts, security and access control. The new user is prompted to set up an account 9 for recording transactions comprising, but not limited to, subscription charges, credits for referral fees and debits for purchases. Optionally, the user may be a member of commonly available payment systems such as, but not limited to, “Pay Pal” and “Yahoo Pay”. Once the user's account is set up, the user is assigned a user defined access control. The new user is then given user access to the products/services catalog and search engine 11, which searches by, but not limited to, categories, keywords, and function and the like.

Existing members 13 access the Global Referral and Buyer's Club for products and services 2 through personal computers, cellular devices, telephones, and the like, or any other access device that may be introduced in the future. Members are connected to the central database server 3 and given user access control 15 once a password is entered and verified. The member then gains access to the products/services catalog and search engine 11.

New users, after completing the enrollment process 10, and members that have gained access to the products/services catalog and search engine 11, can either use the exit-application 14 to exit the central database server 3, or continue to use the catalog or search engine 11. The user can access the database of reviews on products and services of interests 15. If the user desires to purchase or download a product or service, the user accesses the order processing module 19. Then the user scans the computation of weights for reviewer credits 23 and the order is updated in the database and user bank accounts for debits and credits 21. From here, the user may reenter the catalog or search engine 11 to continue use.

The user may use links from the product/service catalog 11 and also access the product/service review area for adding to the review database 17. Here the user can voluntarily write a short review in a pre-determined format about any product or service with which the user has personal experience and can recommend a buy rating, for example, on a scale of 1 to 5, 1 being the lowest rating (avoid) and 5 being the highest rating (highly recommended). Members are required to disclose any conflicts of interest but will be allowed to maintain their anonymity. Based on their experiences, other members rank the user's review for trustworthiness. Rankings are done on a scale of, for example, one to five, one being unreliable and five being the trustworthiest. These ratings are recorded and tracked on the central database.

The user's adding of a review is updated to the database and user bank accounts for debits and credits 21. From here, the central database server 3 either processes a transmission to suppliers 25, or allows the user to return to the product/service catalog and search engine 11.

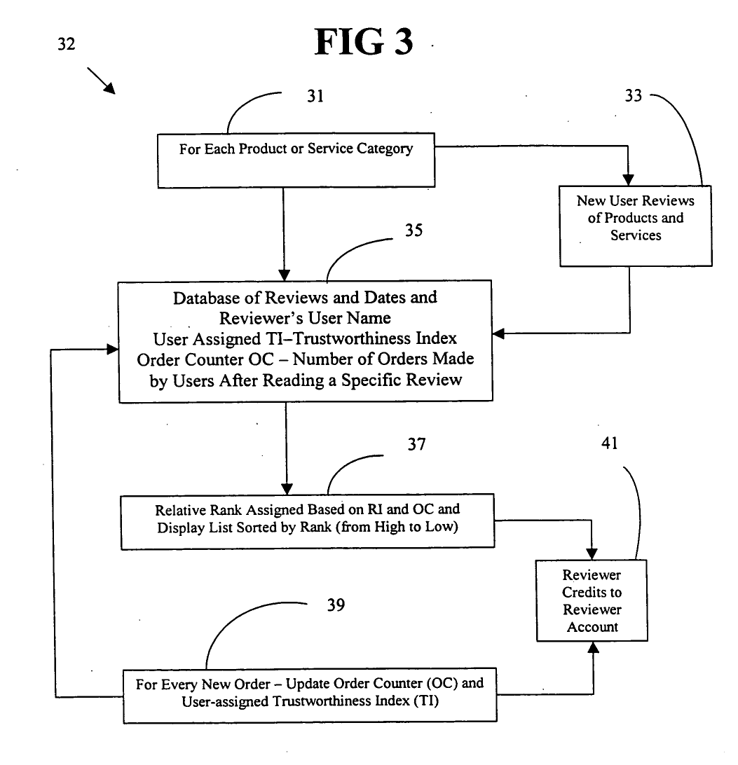

FIG. 3 is a flow chart detailing the review ranking and credit assignment scheme 32. For each product or service category 31, the user can view new user reviews of products and services 33, or enter the database of reviews 35 to view the dates and reviewer's user name. The user can also view the user assigned trustworthiness index (TI), the order counter (OC) or the number of orders made by users after reading a specific view. The user then can refer to the relative rank 37 assigned based on the trustworthiness index and order counter and display list sorted by rank, from high to low. For every new order 39, the order counter and user-assigned trustworthiness index are updated. The reviewer credits are sent to the reviewer account 41. When updated, the order counter and trustworthiness index results are sent to the database of reviews and dates 35 to be updated.

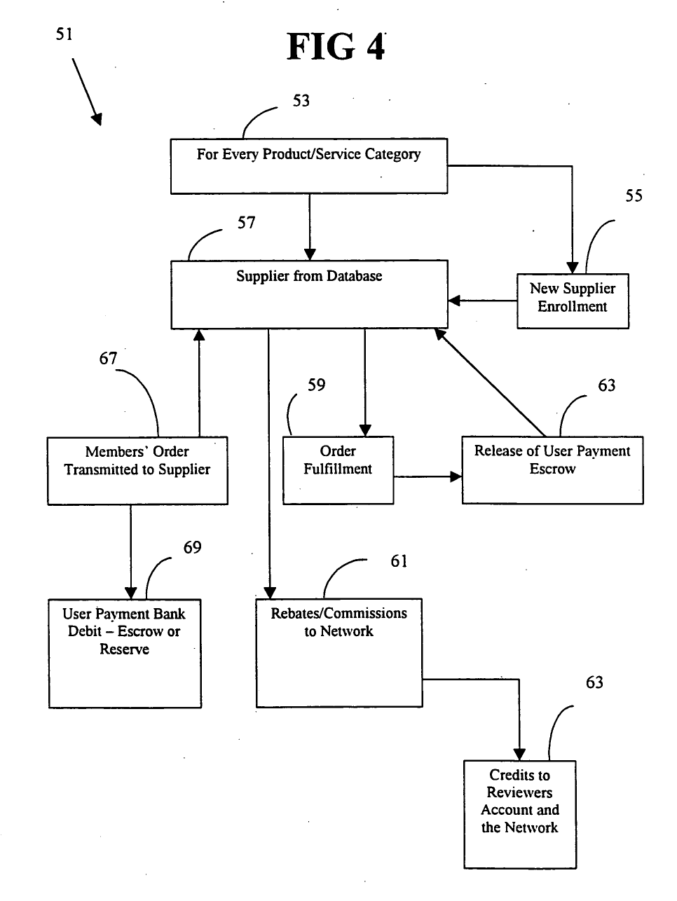

FIG. 4 is a flow chart detailing the global network suppliers' interactions 51. For every product/service category 53, a supplier is provided either from the database 57 or a new supplier enrollment 55. Once the order is filled 59, the user payment escrow 63 is released. A user's order may also be transmitted to a supplier 67, whereupon user payment 69 occurs through bank debit, escrow, or reserve 69. After the user accesses the supplier through the database 57, rebates and/or commissions to the network 61 are transmitted and credits to reviewers account and to the network 63 are also transmitted.

After reading one or a number of reviews, the user places an order online for a product or service by clicking on a small icon. The order is documented and transmitted to the merchant, reseller or distributor for fulfillment. The price of the transaction is entered into a database along with the product and other details. If a member places an order, the database is reviewed for the path taken by that member in arriving at a buy decision and the relative trustworthiness rankings to credit each of the influencer's or reviewer's account with a relative-rank-weighted share of a percent of the transaction price for the product or service.

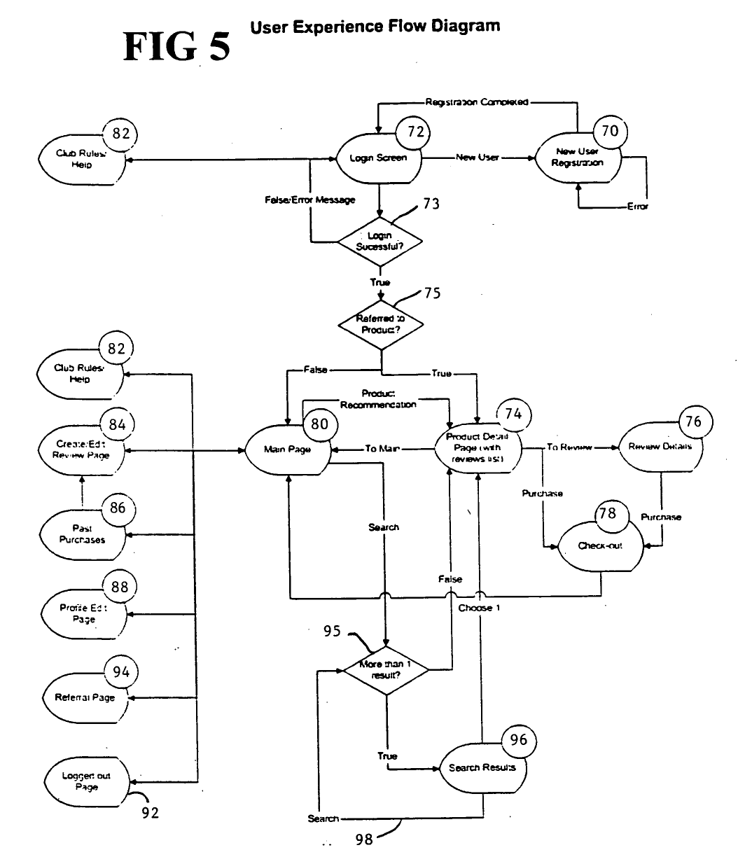

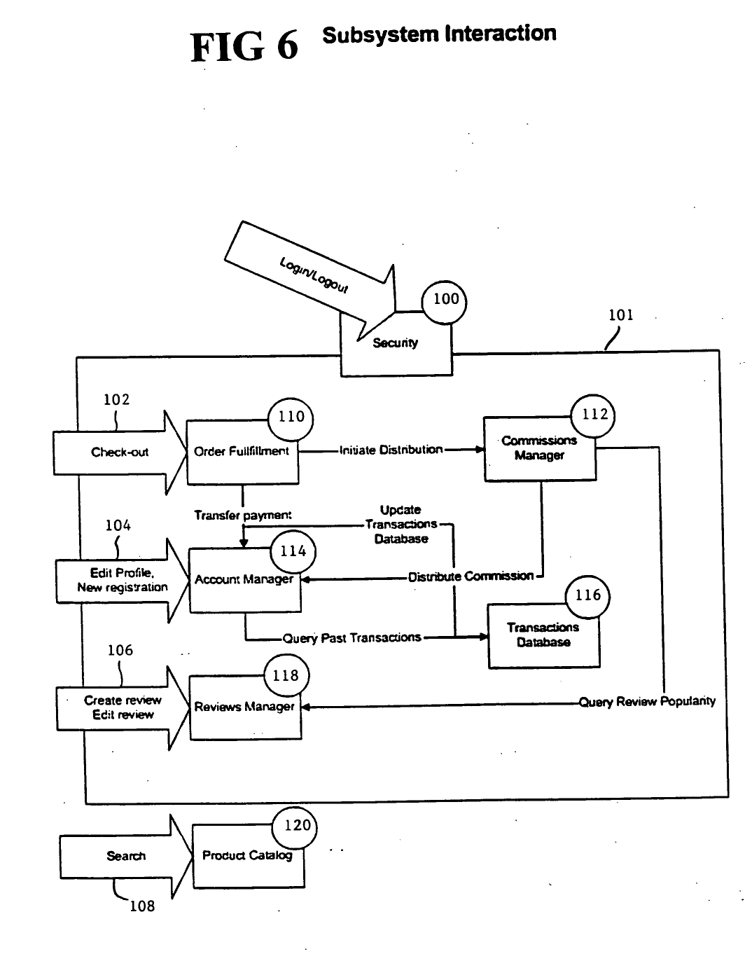

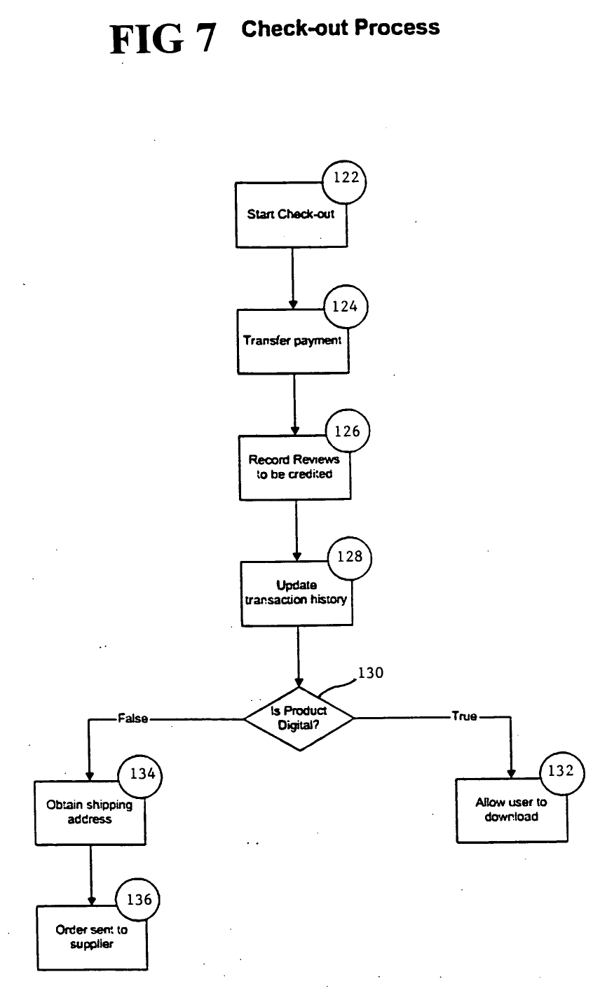

In another preferred embodiment, the PEER BAZAAR system is composed of, for example, four modules; the Financial Transactions Module (FIG. 7), the Review Tracking Module (FIG. 5), the Product Search Module (FIG. 5), and the Account Management Module (FIG. 6). The Financial Transaction Module is responsible for obtaining customer payment information, recording necessary transaction information, routing the transaction through a third party payment destination, and placing an order to the product supplier. The Review Tracking Module is responsible for creating, and managing product reviews. The Product Search Module provides users with the ability to locate specific products and place queries to discover new products within the PB system via a proprietary search engine. The Account Management System is responsible for creation and management of user accounts, the management of user profiles, credit allocation, purchase history, and referral distribution.

FIG. 5 is a flow chart describing the user experience in PEER BAZAAR. If a user is not registered with PEER BAZAAR and desires membership, the user is taken to the new user registration 70 section of the system. Prompting the user for a unique nickname or assigning a unique alphanumeric-ID to ensure the user's anonymity within the system initiates user registration. This process is followed by the submission of a user chosen password. The user then enters his or her profile information, including payment-processing information such as credit card or other micro-payment service IDs such as, but not limited to, “Pay Pal” or “Yahoo Pay,” with the information remaining confidential and private to the specific user. If PEER BAZAAR finds any incorrect or missing information, it will ask the user to re-enter the information. Periodically PEER BAZAAR will ask the user to verify their information.

Upon successful login 73 to PEER BAZAAR from login screen 72, the system will decide if the user entered the system via a product referral 75. If the user was referred, the system immediately displays a list of product reviews 74 which provide insightful information to the user from previous purchasers of the product. This feature is be managed by the review subsystem 76. The user will have the chance to purchase the product at this stage in the system and is provided with the opportunity to give credit to the reviews that influenced the purchase decision. If credit is acknowledged, the respective reviewer's review credits are incremented. If the credit is not acknowledged then all the reviews read by the user gets equal weighted scores. The user then enters the checkout component 78 of the system to finalize the transaction. At this stage, the referrer's referral credits are updated.

If a user was not referred, the user enters the main section 80 of PEER BAZAAR, where several navigation options may be shown. These options include, but are not limited to, Product Search, Club Rules and/or Help 82, Create/Edit Review pages 84, View Past Purchases 86, Personal Profile 88, Referral Tool 94, and Logout 92 of the system. The Club Rules and Help 82 define the regulations and restrictions of becoming a member of PEER BAZAAR club. Create/Edit Review 84 pages provide opportunity for the user to write commentaries of his or her past purchasers. Personal Profile 88 allows the viewing and editing of user specific information including name, address, e-mail, and credit card information. The user may also create a buddy list of existing PEER BAZAAR users, which is utilized by the Referral Tool 94.

The Referral Tool 94 creates a conduit for users to obtain new customers for a product through direct solicitation. This tool allows users to send referral notices to existing and external users of PEER BAZAAR in hopes of stimulating a product purchase. If a referred user purchases a product through the referral, the referrer receives referral credits.

If the user decides to search for a product, a search query 95 is submitted to the system, which in turn returns a list of search results 96. If unsatisfied with the search results, the user has the opportunity to refine the search query through resubmission 98. However, if satisfied, the user can select a product from the search results and enter the product review section 74 described previously.

FIG. 6 is a diagram detailing the PEER BAZAAR subsystem interaction. The subsystems are protected by the security module 100, which protects a set of confidential and private user events and processes. This set may consist of checkout 102, profile editing 104, and review editing 106 and the like. User events such as product searching 108 from product catalogue 120 do not need to be protected by the security module due to its insensitive nature. The security architecture 101 creates a virtual wall to protect the mentioned events through well-proven existing technologies such as “Secure Socket Layer” (SSL). Once the user is ready to checkout 102 the orders are fulfilled 110 and distribution initiated. This triggers the commission manager 112 to review and credit commissions to the account manager 114 as well as triggers the payment transfer which may also be monitored by the accounts manager 114. The system may query and review past transactions from a transaction database 116 before any transaction is completed. The review manager 118 analyzes reviews posted by users and monitors popularity of products independently as well as with data from the commissions manager 112.

FIG. 7 describes the checkout process of PEER BAZAAR. This subsystem is instantiated 122 when the user makes a decision to purchase a product. Payment information 124 is supplied by the purchaser to PEER BAZAAR in the forms of, but not limited to, an electronic payment system such as “Yahoo Pay” or “Pay Pal”, or through a credit card or other payment systems. If the transaction is approved, the subsystem determines if product reviews 126 were used to assist in a purchase decision. If so, PEER BAZAAR allocates review credits to the respective reviewer's accounts or referral credits to those who enabled a sale through a direct referral.

The review credit 126 creates incentive for users to provide insightful feedback to future purchasers of a product on the product's relevant pros and cons. A portion of PEER BAZAAR's margin (from it's distribution agreements with suppliers of products and services) of each purchase is allocated 128 to a credit pool specific to the product. At arbitrary time intervals such as a week, a month, a quarter, or the like, the credit pool is divided amongst reviewers who were recognized, acknowledged and/or cited as providing beneficial insight into the purchase of the product. The distribution of the pool amongst reviewers is allocated based on weighted scores earned by the reviewers. The weighting scheme may be based on any arbitrary scheme such as relative frequency of readership or the credits given by readers prior to making a purchase.

The reviewers are ranked relative to each other over time based on a tool to gauge the value of a review on the Trustworthiness Index. This index indicates the frequency at which purchases were made based on the effectiveness of a review. Users can apply the Trustworthiness Index in deciding which reviews are most beneficial for a product category, and to determine which reviewers consistently provide accurate and trustworthy reviews.

Upon completion of review credit distribution, the subsystem prompts and records all pertinent information necessary to conclude the transaction 128. This information may include, but not be limited to, the purchaser, the product, a shipping address and the like, if for example, the product is non-digital, which includes any consumer goods/services.

Transfer of the product from PEER BAZAAR to the customer may depend whether the product is digital 130 or not. Digital products may be available for immediate download onto the user's electronic device 132. These devices include, but are not limited to, personal computers, cellular devices, modems, MP3 devices, satellite and radio devices, PDAs and/or the like. The digital product uses any and all available copy protection schemes that include among others, but is not limited to, encoding of buyer's information within the digital asset, etc. If the product is non-digital, the user's shipping address 134 is retrieved and supplied along with an order 136 to the supplier of the product for delivery.

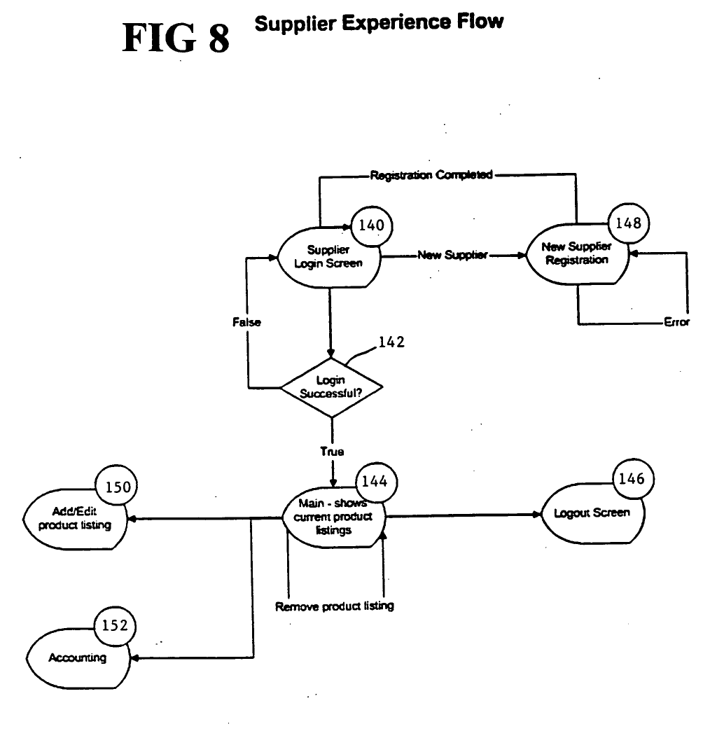

FIG. 8 is a flow chart detailing the supplier's interactions in PEER BAZAAR. This subsystem is responsible for control and management of supplier's products through tools 144 that provide the ability to add/edit products 150 and set price levels, and an accounting system 152 to view revenue information and consumer purchase behaviors. This subsystem can be accessed through a login process 140 where the supplier is authenticated for entry. Upon successful login 142, the supplier has access to the subsystem's management tools 144 and is provided with the ability to logout 146 of the subsystem. If a supplier has not registered with PEER BAZAAR, the supplier must undergo a new supplier registration 148 which must be approved by PEER BAZAAR.

PEER BAZAAR attracts and retains valued customers through an incentive structure. Incentives are placed on product referrals and product reviews. The core component of the incentive structure is the credit, which is awarded with respect to product referrals and reviews. A credit may represent, for example, a financial unit, which allows a PEER BAZAAR user to purchase other products by debiting the user's credit account or which allows the user to simply receive a credit to their account.

PEER BAZAAR is different from existing systems for several reasons. PEER BAZAAR assumes that every buyer of a product is automatically a reseller. The system also provides incentives for consumers and deterrents to minimize piracy. PEER BAZAAR creates a unique method of rating for trustworthiness of reviewers for products and services and creates incentives for them. The system effectively creates a global peer-to-peer distribution channel for both digital and non-digital products and services.

The target audiences for the present system include: consumers that provide detailed reviews of products and services, consumers that provide simple ratings, consumers that browse reviews prior to buying, consumers that sign up to receive product and service alerts, businesses that want to add responses to consumer complaints.

Multiple databases are utilized in the present invention. The databases may be separate or consolidated and are based on MYSQL regional databases. Examples of possible databases include: reviews for each product or service, reviewers with detailed personal information, products and services (including previews of upcoming future products and services), government actions (such as product recalls), public complaints or court judgments on products and services, institutional members (businesses and institutions that provide products and services), payments to reviewers by review, consumers that sign up for entail alerts on specific products and services, and payments from institutional members by product or service category.

Outputs from the system are easy to use. Consumers are able to locate information using keywords and/or hierarchal tree structures. Reviews and other information are arranged by category, manufacturer, product name, brand name, etc. Review output is a standard output that is simple, elegant and user friendly. Additionally, the reviews may contain hyperlinks to help consumers in ordering the product or getting more information.

Businesses and institutions providing goods and services have the ability to generate ad hoc reports by querying the review databases. Allowing these businesses and institutions to subscribe to the site and obtain information regarding reviews of the products or services generates income. Subscriptions to information may be monthly, quarterly, annually, or at any other period. Businesses and institutions get a chance to respond to adverse reviews and responses are displayed for consumers along with the complaints. Previews of upcoming products will also be displayed. Subscribers to the service will also get notices when reviews are posted regarding products and services.

Additionally, managers of the present system can create ad hoc reports from the information in the various databases. Managers are allowed full access to all information.

In a preferred embodiment, not all consumers become reviewers. Anyone can submit a review by filling out a detailed standardized web-based form. If a product or service category does not exist, then any user can suggest a new one that may be added by an editorial board. The editorial board will select any number of reviews, for example but not limited to, anywhere from one to approximately ten reviews for each product and the selected reviewers will earn incentives, such as but not limited to, credits, discounts, payments of set amounts, and the like. Some of the reviewers may be invited to join the editorial board and receive additional incentives, for example, get paid more than the original reviewers. The list of reviews displayed on the system is dynamic and can be changed over time as new reviews are submitted. The editorial board determines the quality of the reviews. Both positive and negative reviews are solicited and used. Reviewers provide detailed personal information and are randomly checked for bias, conflicts of interests, and the like. Consumers may sign up for email alert services for specific products or services.

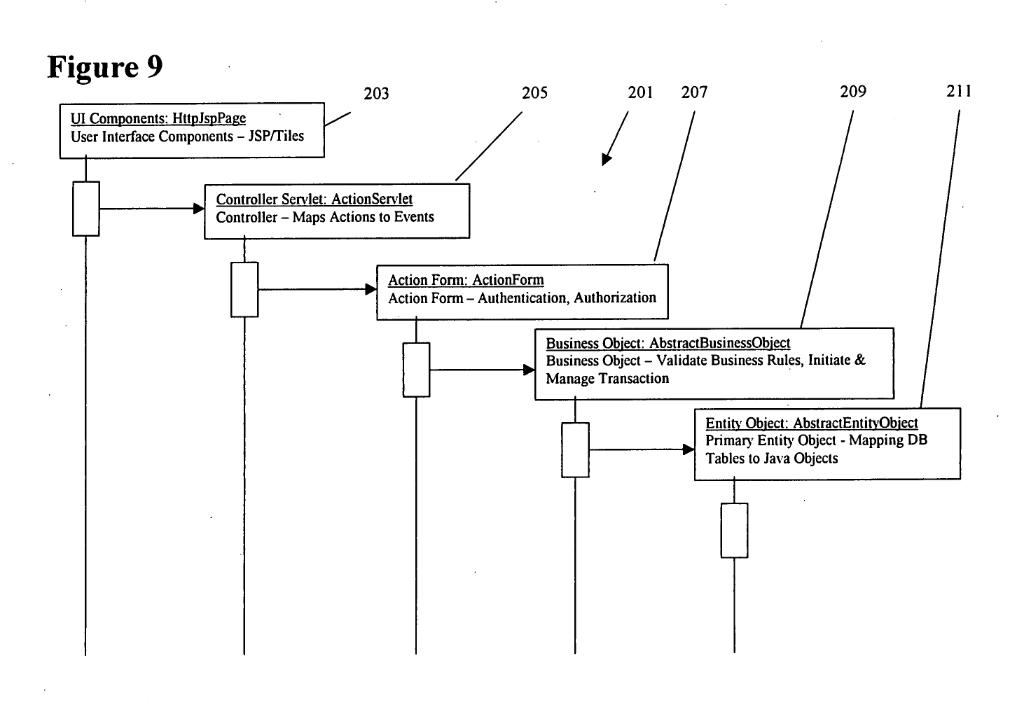

FIG. 9 shows the sequence 201 of invocation of classes when a user triggers an action from the browser. The details of preferred embodiments of each of the classes/layers include, but are not limited to the examples described below:

JSP/User Interface Components 203—This layer may comprise various JSP pages that take input from the user. JSP Pages can be replaced with Tiles (Struts framework). Tiles build on the “include” feature provided by the JavaServer Pages specification to provide a full-featured, robust framework for assembling presentation pages from component parts. Each part (“Tile”) can be reused as often as needed throughout the application. This reduces the amount of markup that needs to be maintained and makes it easier to change the look and feel of a website. Each event triggered in this layer may be mapped to a single, or plural, Controller Servlet.

Controller Servlet 205—This is a Servlet identified in the Struts framework to provide an MVC architectural approach. The main purpose of this is to convert User actions in Business Events identified by the system.

Action Form 207—Action Form classes will extend PeerBazaarAction class. These are basically aimed at form validation, session validation & Authorization. The following include, but are not limited to, the core functionalities:

Validate the session

Verify the permission for the user to access this action (security)

Start the transaction

Execute transaction

End transaction

PeerBazaarAction class extends from the class “org.apache.struts.action.Action”. All Subclasses will override the executeTransaction method to do their transaction. This main functionality of this section is authentication, authorization and Business Event delegation.

Business Objects 209—All Business Objects extend the AbstractBusinessObject and will enforce business rules. These will either use the search package to search or the entity objects to read & write data.

Entity objects 211—The application master data divided into various entity objects for maintaining cache and performing business operation. The entity will contain the code to create, load and save respective data into database. All the entity class could extend from AbstractEntityObject class. Some examples of Entity classes are: User, Address, AttributeGroup, Attribute, Category, Product, Review, Comments, ReportTable, Column, Report, and Filter.

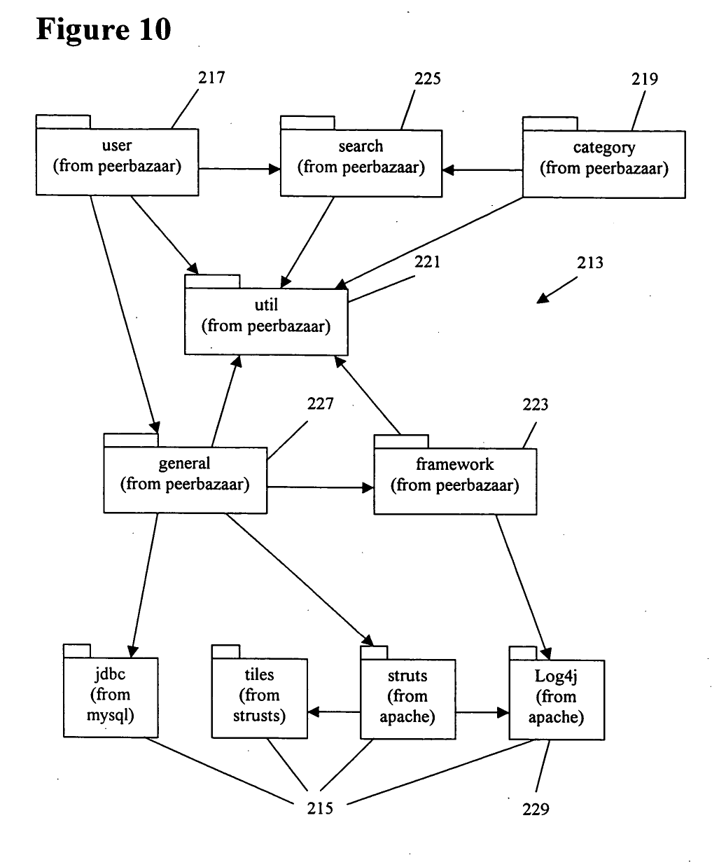

FIG. 10 is a package diagram 213 and displays various packages involved in the application. Packages displayed in the bottom row are the third party packages 215 that are used. com.peerbazaar.user 217 & com.peerbazaar.category 219 are sample packages created for understanding purposes. Each of the packages has one or more Business Objects 209 that enforce business rules. All business objects extend the AbstractBusinessObject class.

com.peerbazaar.util 221—Contains utility classed which can be used across the application, exemplary instances: HtmlUtils, StringUtils, and StringCrypt.

com.peerbazaar.framework 223—Contains base classes of the framework, exemplary instances: AbstractEntityObject, AbstractFactory, Giver, Transaction, and TransactionManager.

com.peerbazaar.search 225—Contains framework for search functionality, exemplary instances: Search, CachingSearch, SearchRequest, and SearchResults.

com.peerbazaar.general 227—Contains exemplary wrapper classes for data source, action, action form and giver.

com.peerbazaar.user 217—Contains exemplary user management related classes.

com.peerbazaar.category 219—Contains exemplary category management related classes.

Logging—The application may use Log4j API 229 for logging. The logger can be retrieved from giver by accessing the method “giver.getLoggero”. The method returns an object of class org.apache.log4j Logger. The following method is used to log the message.

Logger.log(Priority, message);

Logger includes the following non-limiting priorities

1. DEBUG—this is used for the developer to debug the error. This log message will not be printed in production server.

2. INFO—this is used to log messages, such as time of use logged, logout, all operations in entity objects like load, save, delete and insert.

3. WARN—this is used to log messages related to security. For example, if the user trying to access a page without enough permission will not be logged.

4. ERROR—this is used to log messages about the data inconsistency. All the messages related to support team would be logged at this level.

5. FATAL—this is used to log messages about the crash in PEER BAZAAR application.

Encryption—The class “StringCryptjava” provides method for encryption and decryption.

Security—Security check is handled in PeerBazaarAction class. For each request based on user's role the feature will be checked to access the page.

DB Configuration—Connection pooling will be done in the JBoss Application server. The administrator will configure the connection pools prior to deploying the application.

The following are the major components involved in the framework. The list is not exhaustive and is only exemplary.

Giver—This is a singleton class, and responsible for holding reference for all factories instance.

Factory—Each entity type will have a factory to maintain the cache. All entity objects should be retrieved from factory. All the factory class may extend from AbstractFactory.

AbstractEntityObject—All the entity class will be extended from this class. This class has common methods like load, save, insert and delete.

PeerBazaarAction—This class extends from the class “org.apache.struts.action.Action”. All the action class will be extended from this action. Subclass will override the executeTransaction method to do their transaction. This may include the following exemplary functionalities:

1. Validate the session

2. Verify the permission for the user to access this action (security)

3. Start the transaction

4. Execute transaction

5. End transaction

AbstractBusinessObject—This abstract class provides the basic prototype for each of the business Rule Management classes. An example of business rule is to check for user duplication when a new user is being created.

New features of the present invention include, but are not limited to: Registered User Sign-Up page, Reviewer Sign-Up page, Home page, Product Search, Advanced Product Search, Category drilldown, Product Details page, Write Review, List reviews, Subscribe email alert for Product/Category, Invite friend to join PEER BAZAAR, Email alert configuration, Change password, Suggest Produci/Category, View suggested Products/Categories, My PEER BAZAAR, My Account, Approve/Reject review, and Confirm/Withdraw review for reviewer.

In summary, PEER BAZAAR is an e-commerce system that sells a variety of products and/or services online. Customers are attracted to purchasing online from a web site that provides unbiased, truthful product reviews and at the same time delivers low cost, efficient, hassle free buying experience. Currently, product reviews are available on Internet sites such as AMAZON, EBAY, and CNET. However, these reviews may be biased, not truthful and lack quality control. These sites accept advertising dollars from the manufacturers and as a result their impartiality is lost.

PEER BAZAAR improves on these previous methods by:

1. Offering incentives to the user of products to write accurate, extensive, truthful reviews using PEER BAZAAR's protected business method process. Competition is introduced for the reviewers by paying only the top ten reviewers of any product and then by continuously updating the top ten reviews periodically. In addition to initial payment for selected reviewers, a portion of commission received by PEER BAZAAR is paid to the reviewers as the products are sold.

2. PEER BAZAAR uses traditional discount available from normal Internet sale sites as well as creates relationships with other sites and manufacturers.

3. Consumers are asked to write reviews about products that each consumer is using and that are not currently in the PEER BAZAAR database. When enough interest is generated, PEER BAZAAR will offer that product to consumers. In this manner, PEER BAZAAR offers items that are most demanded by the consumer.

The following is an example of, but not limited to, a preferred embodiment of PEER BAZAAR transactions. At startup, the current system offers products in, for example, 5 categories: music, magazines, books, software and videos. In all, at startup, a number of lines, for example, 10 product lines are offered. PEER BAZAAR may get, for example, 10 reviews on about 100 products (10 products in each of the 10 categories) before the launch. In this way the customers to the web site have products to review and buy. In addition, consumers are asked to write reviews on new products they are currently using. This gives the current system additional leads on products that customers want and builds the database.

The consumers of the product review are paid some incentive, for example, approximately 100 dollars each once a certain number, for example, ten viable product reviews are received and accepted by the editors of PEER BAZAAR, and PEER BAZAAR decides to offer that product for purchase. The top ten reviewers may be paid a commission, in this example, ⅓ of the commission received by PEER BAZAAR anytime a product is purchased. In addition, when a consumer purchases one of these products, they are encouraged to fill out a survey form. Every six months, editors of PEER BAZAAR review the submitted reviews for a given product and select new top ten reviews. The new reviewers are paid incentives, for example, approximately 25 dollars for the review and are now entitled to the commission on the product as the product is sold.

Once a consumer reads a review (or reviews) hr/she has the option to buy the product from PEER BAZAAR. The actual sale may be directly from the retailer or from one of the Internet sales channels such as AMAZON, CNET, YAHOO, etc., depending on what PEER BAZAAR has negotiated. In each case, PEER BAZAAR strives to offer the lowest cost to the customer. With each sale of this type, PEER BAZAAR receives a commission. These commissions provide the revenues for the company in addition to other resources, such as but not limited to, membership dues.

The significance of PEER BAZAAR's technology is not only in the benefit that it provides consumers, but also in the advantages it provides for vendors. PEER BAZAAR provides vendors with additional marketing channels on which to sell their goods. In addition to this, PEER BAZAAR provides vendors with access to large pools of marketing and survey data. Access to this data provides a second source of revenue for PEER BAZAAR. Participating vendors are charged a fee, for example, approximately 1000 dollars per year per product/service for access to PEERBAZAAR's data and research.

Some other advantages for suppliers include, but are not limited to: Lower cost than mass-market promotions or advertisement campaigns, lower distribution and sales costs, supports JIT production, piracy protection solution for digital asset sales (movies, video's, etc.), and the like.

The current system is useful to distribute music, magazines, books, software and videos and all other consumer/business oriented products and services via the Internet. The use of peer-to-peer recommendation and distribution is already very popular, and the unique system of the present invention allows for more helpful reviews and purchasing and with the unique incentive system helps prevent web piracy. Digital as well as non-digital products and services may be distributed and reviewed. The technology offers consumers the ability to recommend products to one another and purchase products they decide to buy. Given that none of the on-line sales channels offer this ability, PEER BAZAAR fulfils that need. PEER BAZAAR provides customers unparalleled, cost effective product purchasing experience by providing them with accurate product reviews by peer product users, and buying from sales channel that is most efficient in terms of price and convenience.

PEER BAZAAR generates revenues from several sources. For example, PEER BAZAAR may charge suppliers a fee per product listing per month to list their products in their database. Another form of revenue may come from commissions from products sold through the PEER BAZAAR site. Other revenue sources are well within the scope of this invention.

The prime competition for the current system comes from the online review markets that are either based on an advertising model (CNET and EPINIONS) or e-commerce and order fulfillment (AMAZON and BEST BUY). All of these sites provide reviews of products, however, the reviews are not as extensive as the ones that will be provided by PEER BAZAAR. In some cases the quality of the review is suspect since these sites accept advertising and other considerations from the suppliers.

PEER BAZAAR differentiates itself from competitors by providing truthful, unbiased, extensive reviews of products. The review by the customer is filled online and experienced PEER BAZAAR consumers judge its quality. Despite the growing number of websites, the quality and breadth of information remains limited. As indicated above, a number of websites exist that provide information on products; the reviews are not comprehensive.

Another main differentiator between the current system and the existing competitors is the quality and validity of the PEER BAZAAR reviews. Today's reviews are often written by biased individuals or are so high level they do not add much credible value. As a result, many Internet buyers today act on gut feeling or good faith. PEER BAZAAR reviews structure and completeness and the review process is much more valuable and complete. The reviews consist of a very detailed questionnaire. Reviewers are asked to sign a letter to say that they have purchased and used the product. The proof of purchase (i.e., UPC label) is verified in some instances. The questionnaire has questions that try to ascertain whether the buyer has used the product. The incentive for the reviewer to do a thorough job includes initial payment and commissions for at least six months if their review is among the top ten reviews of the product, as determined by PEER BAZAAR editors.

While the invention has been described with reference to specific embodiments, modifications and variations of the invention may be constructed without departing from the scope of the invention, which is defined in the following claims.

We claim:

1. A global sales by referral method comprising providing a central database server, storing data of products and/or services in the server, communicating with the server via internet with remote access devices, accessing the stored data via the access devices, inputting reviews of reviewers about the products and/or services via the access devices, accessing the reviews, and making choices about the products and/or services responsive to accessed reviews.

2. The method of claim 1, wherein the inputting the reviews further comprises posting the reviews for each category of the products and services.

3. The method of claim 1, wherein the inputting the reviews comprises storing the reviews in a database on the server.

4. The method of claim 1, wherein the accessing the reviews comprises accessing reviews for each category of the products and services.

5. The method of claim 1, wherein the accessing comprises accessing new user reviews and/or the database of stored reviews.

6. The method of claim 1, wherein the making choices comprises performing a transaction responsive to the review and sending review credits to a reviewer whose review of the products and/or services triggers the transaction.

7. The method of claim 6, wherein the sending review credits comprises sending the review credits to the reviewer's account, storing the review credits in the reviewer's account, accessing the review credits when the reviewer desires, and trading the review credits for transactions from the reviewer's account.

8. The method of claim 1, wherein the storing data of the products and/or services comprises allowing access to the server for authorized manufacturers and/or suppliers of products and/or services, inputting data about the product and/or services, and allowing users access to the data.

9. The method of claim 1, further comprising placing orders of desired products and/or services from the database, fulfilling the orders from users, accessing user accounts for payments, monitoring the reviews accessed by users and their responsive orders, and sending review credits to reviewer's account.

10. The method of claim 1, wherein communicating with the server via access devices comprises communicating with devices selected from the group consisting of computers, personal computers, cellular devices, telephones, modems, radio devices, PDAs, MP3 devices, satellite devices and combinations thereof.

11. The method of claim 1, wherein the accessing the database comprises enrolling users as members, alerting users to rules governing all transactions, prompting users to enter user-identifier information, and registering users as members.

12. The method of claim 11, wherein the prompting comprises allowing users to select a unique identifier, registering users as members and allows users to maintain anonymity.

13. The method of claim 12, wherein the selecting a unique identifier comprises selecting an identifier from the group consisting of screen names, passwords, code-names, pseudonyms, alpha-numeric codes, and combinations thereof.

14. The method of claim 13, further comprising allowing users input profiles about themselves.

15. The method of claim 11, wherein the enrolling comprises updating new users enrollment data in the central server, screening the enrollment data for conflicts, security and access control, and prompting new users to set up an account for recording transactions.

16. The method of claim 15, wherein the enrolling further comprises allowing users to choose from payment options selected from the group consisting of credit cards, debit cards, online banking, Pay Pal, Yahoo Pay, escrow accounts reserve accounts, and combinations thereof.

17. The method of claim 16, wherein the recording transactions comprises recording in user accounts credits for referral fees and debits for purchases.

18. The method of claim 17, wherein the enrolling further comprises assigning registered users user-defined access control after setting-up users account.

19. The method of claim 1, wherein the accessing the database comprises browsing catalogued products and/or services via search engines and links.

20. The method of claim 19, wherein the browsing via search engines comprises searching using terms selected from the group consisting of product and/or service categories, keywords, functions, and combinations thereof.

21. The method of claim 1, wherein the inputting reviews comprises voluntarily inputting reviews in pre-determined formats about any product and/or service used by the user.

22. The method of claim 21, wherein the inputting reviews comprises accessing a database of ratings for each product and/or service and inputting respective ratings corresponding to the reviews input by users.

23. The method of claim 22, wherein the inputting reviews comprises disclosing any conflicts of interest.

24. The method of claim 21, wherein the inputting reviews further comprises ranking users reviews for trustworthiness by other users based on their experiences on a trustworthiness ratings scale, tracking and storing the trustworthiness ratings on the central server, and allowing access to other users.

25. The method of claim 1, further comprising updating the database for the data about the products and/or services, updating reviews on the database, and updating user accounts for posting debits and credits.

26. The method of claim 1, further comprising processing user input data in the central database server, transmitting purchase data to manufacturers and/or suppliers, crediting and/or debiting user accounts and allowing users to return to the product and/or service catalog and search engine.

27. Global sales referral network comprising a central server, a database of products and/or services on the server from manufacturers and/or suppliers, access devices communicating with the server via internet, authorized members communicating with the servers via the access devices, peer reviews about the products and/or services posted by the authorized members, and credits posted to member accounts for every review triggering a transaction from other members.

28. The network of claim 27, wherein the access devices are selected from the group consisting of computers, personal computers, cellular devices, telephones, radio devices, satellite devices, PDAs, MP3 devices, and combinations thereof.

29. The network of claim 27, wherein the database further comprises unique identifiers corresponding to each member for allowing network access to the respective member.

30. The network of claim 27, wherein the database further comprises products/services catalogs and a search engine for searching the database.

31. The network of claim 27, wherein the database further comprises search parameters for searching the database responsive to user queries.

32. The network of claim 27, wherein the peer reviews comprise reviews of products and/or services used by a member and ratings corresponding to the reviewed product and/or service.

33. The network of claim 27, further comprising an order-processing module for processing orders from members.

34. The network of claim 27, further comprising reviewer credits posted to reviewer accounts for every transaction triggered by a respective peer review by the member.

35. The network of claim 27, further comprising member accounts for crediting reviewer credits and for debiting payments towards transactions initiated by the respective members.

36. The network of claim 27, wherein the peer reviews are constantly updated and comprise data selected from the group consisting of new user reviews and/or stored reviews for each product and/or service, dates the peer reviews were posted, reviewer's user name, assigned trustworthiness index, order counter, number of orders made by users after reading a specific peer review, relative rank assigned to a product and/or service based on the trustworthiness index and order counter, display list sorted by rank, from high to low, and combinations thereof.

37. The network of claim 27, wherein the database comprises details of global network manufacturers and/or suppliers for every product and/or service category.

38. The network of claim 27, further comprising documentation for every transaction initiated by members and transmitted to merchants, resellers or distributors for fulfillment.

39. The network of claim 38, wherein the documentation further comprises price of the transaction, product details, peer reviews accessed, reviewer credits to be posted to peer reviewer user account and relative-rank-weighted share of a percent of transaction price for the product or service to be posted to the server and member accounts.

40. A global sales by referral network system comprising a central server comprising a product search module, a review tracking module, a financial transactions module and an account management module, and access devices communicating with the server via internet.

41. The system of claim 40, wherein the product search module comprises a database for user access, wherein the database comprises data about specific products and/or services and a proprietary search engine for allowing user queries to find products and/or services within the system.

42. The system of claim 40, wherein the review tracking module creates, stores and manages product reviews from users, analyzes reviews posted by users and monitors popularity of products independently as well as with data from the other modules.

43. The system of claim 40, wherein the financial transaction module obtains customer payment information, records necessary transaction information, queries and reviews past transactions from a transaction database before any transaction is completed, routes transaction through third party payment destinations, and places an order to a source of a requested product and/or service.

44. The system of claim 40, wherein the account management module creates and manages user accounts, user profiles, reviewer credit allocation, purchase history, and referral distribution.

45. The system of claim 40, further comprising a security module for protecting confidential and private user events, transactions, and processes.

46. The system of claim 45, wherein the security module comprises checkout, profile editing, review editing and the like.

47. The system of claim 46, wherein the security module comprises a security architecture forming a virtual wall for protecting all transactions in the system.

48. The system of claim 40, further comprising order fulfillment manager for fulfilling orders, distribution manager, commission manager to review and credit commissions to the accounts management module and trigger payment transfers monitored by the accounts management module.

49. A global referral network method comprising providing a central server, maintaining a database of products and/or services and related sources for respective products and/or services, maintaining a database of member reviews of the products and/or services, communicating access devices with the central server via internet, registering a user desiring membership, routing the user to a user registration section, prompting the user for a unique identifier, ensuring the user's anonymity, submitting the user identifier, optionally entering the user's profile information, including payment-processing information, detecting incorrect and/or missing information, asking the user to re-enter correct and/or missing information and periodically requesting the user to verify their information.

50. The method of claim 49, further comprising logging-in members from a login screen, reviewing member log-in to determine entry via a product and/or service referral review, if the member enters via referral reviews immediately displaying a list of product and/or service reviews, providing insightful information to the user from previous members reviews of the product, and allowing members to make choices responsive to the product and/or service referral reviews.

51. The method of claim 49, further comprising allowing members to purchase the product at this stage and automatically posting reviewer credit to the reviews of the member account triggering the transaction that influenced the purchase decision.

52. The method of claim 51, further comprising acknowledging the reviewer credit and incrementing the respective reviewer's review credits.

53. The method of claim 52, wherein if the reviewer credit is not acknowledged then posting all the reviews read by the member equal weighted scores.

54. The method of claim 53, further comprising allowing the member to enter a checkout component, finalizing the transaction and updating reviewer's referral credits to the reviewer member's account.

55. The method of claim 54, wherein if the user is not referred, allowing the user entry into the main section and displaying several navigation options which include, but are not limited to, product search, club Rules and/or help, create/edit review pages, view past purchases, personal profile, referral tool, and logout from the network.

56. The method of claim 55, wherein the displaying comprises displaying club rules and help for educating users about regulations and restrictions for becoming a member.

57. The method of claim 55, wherein the displaying comprises displaying create/edit review for providing opportunity for users to write reviews of their past transactions.

58. The method of claim 55, wherein the displaying comprises displaying personal profile information for viewing and editing of user specific information including name, address, e-mail, credit card information, and creating a buddy list of members utilized by a Referral Tool.

59. The method of claim 49, further comprising a referral tool for creating a conduit for users to obtain new customers for a product through direct solicitation, allowing users to send referral notices to existing and external users of the network, stimulating a product purchase, and receiving referral credits if a referred user purchases a product through the referral.

60. The method of claim 49, further comprising allowing the user to search for a product, submitting a search query, returning a list of search results, if user unsatisfied with the search results allowing the user to refine the search query through resubmission, and if satisfied allowing the user select a product from the search results and enter the product review section.

61. The method of claim 49, further comprising protecting the network by a security module, protecting confidential and private user events, transactions, and processes.

62. The method of claim 62, wherein the protecting events comprises protecting checkout, profile editing and review editing and all user transactions.

63. The method of claim 62, wherein the protecting comprises forming a security architecture and creating a virtual wall to protect the events through well-proven existing technologies such as “Secure Socket Layer” (SSL).

64. The method of claim 49, further comprising fulfilling and distributing orders once the user is ready to checkout, triggering a commission manager to review and credit commissions to an account manager, triggering payment transfer which may also be monitored by the accounts manager, querying and reviewing past transactions from a transaction database before any transaction is completed.

65. The method of claim 49, further comprising analyzing posted reviews with a review manager, monitoring popularity of products independently as well as with data from the commission manager.

66. The method of claim 49, further comprising allowing users to check out, instantiating the checkout when the user purchases a product, supplying payment information of the purchaser in the forms of, but not limited to, an electronic payment system such as “Yahoo Pay” or “Pay Pal”, or through a credit card or other payment systems, approving the transaction, determining if product reviews were used to assist in a purchase decision, and allocating review credits to respective reviewer's accounts or referral credits to those who enabled a sale through a direct referral.

67. The method of claim 66, wherein the allocating review credits comprises creating incentive for users to provide insightful feedback to future purchasers of a product on the product's relevant pros and cons.

68. The method of claim 67, wherein the allocating further comprises allocating a portion of the network's margin of each purchase from distribution agreements with suppliers of products and services to a credit pool specific to the product and at arbitrary time intervals such as a week, a month, a quarter, or the like, dividing the credit pool amongst reviewers who were recognized, acknowledged and/or cited as providing beneficial insight into the purchase of the product.

69. The method of claim 68, wherein the dividing the credit pool comprises distribution of the pool amongst reviewers based on weighted scores earned by the reviewers.

70. The method of claim 69, wherein the earning the weighted scores comprises weighting based on any arbitrary scheme such as relative frequency of readership or credits given by readers prior to making a purchase.

71. The method of claim 49, further comprising ranking the reviewers relative to each other over time based on a tool to gauge the value of a review on the trustworthiness index, wherein the index indicates the frequency at which purchases were made based on the effectiveness of a review.

72. The method of claim 71, wherein the ranking comprises applying the trustworthiness index in deciding which reviews are most beneficial for a product category, and determining which reviewers consistently provide accurate and trustworthy reviews.

73. The method of claim 49, further comprising completion of review credit distribution, prompting and recording all pertinent information necessary to conclude the transaction, wherein the information may include, but not be limited to, the purchaser, the product, a shipping address and the like, if for example, the product is non-digital.

74. The method of claim 49, further comprising determining if the product and/or service is digital or not and if the product and/or service is digital making it available for immediate download onto the user's access device which include, but are not limited to, personal computers, cellular devices, modems, MP3 devices, PDAs, radio devices, satellite devices and/or the like.

75. The method of claim 74, wherein the digital product and/or service is copy protected and comprises encoding of buyer's information within the digital asset.

76. The method of claim 74, wherein if the product and/or service is non-digital, retrieving the user's shipping address and supplying along with an order to the source of the product and/or service for delivery.

77. The method of claim 49, further comprising control and management of supplier's products through tools that provide the ability to add/edit products and set price levels, an accounting system to view revenue information and consumer purchase behaviors, accessing through a login process where the supplier is authenticated for entry, upon successful login, allowing the supplier access to the tools and providing with the ability to logout, and if a supplier has not registered, allowing the supplier register through a new supplier registration process approved by the network.

78. The method of claim 49, further comprising attracting and retaining valued members through incentives placed on product referrals and product reviews.

79. The method of claim 78, wherein the incentives comprise awarding credits with respect to product referrals and reviews.

80. The method of claim 79, wherein the awarding credits comprises awarding financial units and allowing a user to purchase other products by debiting the user's credit account or allowing the user to simply receive a credit to their account.

81. A global sales by referral method comprising:
providing a central database server,
storing data in the central database server,
communicating with the central database server via internet with remote access devices,
accessing the stored data via the access devices,
providing incentives for reviewers to write reviews,
inputting the reviews of the reviewers about products and services in the central database server via the access devices,
categorizing the reviews in the central database server,
accessing the reviews via the access devices,
making choices about the products and/or services responsive to accessed reviews.

82. The method of claim 81, wherein the providing incentives comprises awards for referrals and/or product reviews.

83. The method of claim 82, wherein the incentives are financial units and/or credits toward future purchases.

84. The method of claim 81, further comprising inputting the best reviews of the reviewers in the central database server.

85. The method of claim 84, wherein incentives are provided only to the reviewers providing the best reviews.

86. The method of claim 84, further comprising overseeing, analyzing, and selecting best reviews for each product and/or service by an editing board.

87. The method of claim 86, wherein the editing is performed by a neutral party.

88. The method of claim 87, wherein the editing is performed by select reviewers.

89. The method of claim 88, further comprising providing additional incentives to reviewers selected for editing.

90. The method of claim 81, further comprising providing ratings for trustworthiness of products and services.

91. The method of claim 90, wherein the providing ratings is by the reviewers.

92. The method of claim 91, further comprising providing incentives to businesses and institutions receiving positive ratings.

93. The method of claim 81, wherein the accessing of the central database server is done by consumers.

94. The method of claim 93, wherein the consumers accessing comprises accessing reviews of products and services, providing ratings, browsing reviews prior to buying, and signing up to receive product and service alerts.

95. The method of claim 81, wherein the accessing of the server is done by businesses and institutions providing products and/or services.

96. The method of claim 95, wherein the businesses and institutions access reviews of products and/or services, consumer complaints, and sales figures.

97. The method of claim 81, wherein the central database server comprises multiple separate databases.

98. The method of claim 97, wherein the multiple separate databases comprise reviews for each product and/or service, reviewers with detailed personal information, products and/or services (including previews of upcoming future products and services), government actions (such as product recalls), public complaints, court judgments on products and/or services, institutional members (businesses and institutions that provide products and services), payments to reviewers by review, consumers signing up for email alerts on specific products and services, and payments from institutional members by product and/or service category.

99. The method of claim 81, wherein information from the central database server is accessed by keywords and hierarchal tree structures.

100. The method of claim 81, wherein reviews are updated regularly.

101. The method of claim 81, wherein the reviewers submitting the best reviews are compensated.

102. The method of claim 81, further comprising soliciting reviews of products/services not in the central database server.

103. The method of claim 102, further comprising updating the products and services in the central database server based on the reviews of the products and/or services not in the central database server.

104. The method of claim 81, further comprising providing commission on sales of reviewed products and/or services for reviewers selected by an editorial board.

105. The method of claim 81, further comprising receiving a commission on sales of products and/or services in the central server database from businesses and institutions.

106. The method of claim 81, further comprising selling subscriptions for reviews and other information to businesses and institutions providing products and services.

107. The method of claim 81, further comprising validating the reviews by randomly verifying reviewer information.

108. The method of claim 107, further comprising removing biased reviews and reviews influenced by conflict of interest.

109. A global sales by referral method comprising:
providing a central database server,
storing data of products and/or services in the server,
entering subscription agreements for access to the data of products and/or services,
communicating with the server via internet with remote access devices,
accessing the stored data via the access devices,
reviewing products and/or services,
writing reviews of the products and services, and
making choices about the products and/or services responsive to the accessed stored data.

110. The method of claim 109, further comprising purchasing the products and/or services.

111. The method of claim 110, further comprising charging a transaction fee for purchasing the products and/or services.

112. The method of claim 109, further comprising charging a subscription fee for entering into subscription agreements.

113. The method of claim 112, wherein the subscription fee is greater than or equal to zero.

114. The method of claim 112, wherein businesses pay the subscription fee for responding to reviews.

115. The method of claim 112, wherein the subscription fees complement transaction fees for purchasing the products and/or services.

116. The method of claim 109, further comprising referring products and/or services to other subscribers.

117. The method of claim 116, further comprising providing incentives for referring products and/or services.
